(19) United States
(12) Patent Application Publication
(10) Pub. No.: US 2024/0111829 A1
(43) Pub. Date: Apr. 4, 2024

(54) MULTI-VIEW CLUSTERING METHOD AND SYSTEM BASED ON MATRIX DECOMPOSITION AND MULTI-PARTITION ALIGNMENT

(71) Applicant: ZHEJIANG NORMAL UNIVERSITY, Jinhua (CN)

(72) Inventors: Xinzhong ZHU, Jinhua (CN); Huiying XU, Jinhua (CN); Miaomiao LI, Jinhua (CN); Wenxuan TU, Jinhua (CN); Chen ZHANG, Jinhua (CN); Hongbo LI, Jinhua (CN); Jianping YIN, Jinhua (CN); Jianmin ZHAO, Jinhua (CN)

(73) Assignee: ZHEJIANG NORMAL UNIVERSITY, Jinhua (CN)

(21) Appl. No.: 18/275,814

(22) PCT Filed: Jun. 15, 2022
(86) PCT No.: PCT/CN2022/098951

§ 371 Date: Aug. 4, 2023

(30) Foreign Application Priority Data
Jun. 24, 2021 (CN) 202110705655.9
Nov. 10, 2021 (CN) 202111326424.3

(51) Int. Cl. G06F 17/16; G06F 17/11

(52) U.S. Cl. CPC G06F 17/16; G06F 17/11

(57) ABSTRACT

A multi-view clustering method and system based on matrix decomposition and multi-partition alignment are provided. The multi-view clustering method based on matrix decomposition and multi-partition alignment includes: S1: acquiring a clustering task and a target data sample; S2: decomposing multi-view data corresponding to the acquired clustering task and the acquired target data sample through a multi-layer matrix to obtain a basic partition matrix of each view; S3: fusing and aligning the obtained basic partition matrix of each view by using column transformation to obtain a consistent fused partition matrix; S4: unifying the obtained basic partition matrix of each view and the consistent fused partition matrix, and constructing an objective function corresponding to the unified partition matrix; S5: optimizing the constructed objective function to obtain an optimized unified partition matrix; and S6: performing spectral clustering on the obtained optimized unified partition matrix to obtain a final clustering result.

### CROSS REFERENCE TO THE RELATED APPLICATIONS

This application is the national phase entry of International Application No. PCT/CN2022/098951, filed on Jun. 15, 2022, which is based upon and claims priority to Chinese Patent Application No. 202110705655.9, filed on Jun. 24, 2021; and Chinese Patent Application No. 202111326424.3, filed on Nov. 10, 2021, the entire contents of which are incorporated herein by reference.

### TECHNICAL FIELD

The present application relates to the technical field of unsupervised clustering, and in particular to a multi-view clustering method and system based on matrix decomposition and multi-partition alignment.

### BACKGROUND

Multi-view data refers to a large amount of data that describes the same batch of samples from different sources, or with different attributes. For example, an item can be represented by a picture and a short text description; a person can be identified from the face, voice, fingerprints, and pupils. Based on a large amount of unlabeled multi-view data, multi-view clustering has been developed and attracted great attention. Existing multi-view clustering algorithms can be further classified into four categories by model-based differences: co-training, multi-kernel learning, graph clustering, and subspace clustering. For the above four methods, the basic idea of early fusion can be used for view fusion. The main idea of early fusion is to fuse the feature representations or graph structures of a plurality of views into a common representation or one common graph structure. For example, graph-based clustering methods construct sample similarities under each view, and then fuse the graphs via a random walk strategy. The multi-kernel learning method fuses a plurality of base kernels through linear or nonlinear combinations to obtain an optimal clustering kernel. The purpose of subspace clustering is to find a suitable low-dimensional representation or structure for each view, and then fuse them into one common representation or structure containing rich information for clustering. Moreover, there is a way of late fusion in addition to early fusion of views. This method is to fuse the clustering results of the single views, and is also called decision-level fusion. Late fusion can be classified into ensemble learning and collaborative training. The input to the integrated clustering algorithm is the clustering results corresponding to a plurality of views. As in the work, the clustering result is obtained by defining the distance between the final clustering result and the input clustering result as a common loss function. The focus of collaborative training is how to obtain better clustering results in collaborative training. A plurality of clustering results are obtained by spectral embedding for each view, and the obtained clustering results are used to influence the original representations of other views. In addition, late fusion is applied to multi-kernel k-means clustering, which reduces the complexity and time cost of the algorithm.

NMF is widely used for clustering because of its ability to handle basic representations that capture different viewpoints. Some work reduces redundancy between different view representations by defining diversity. Furthermore, both cross-entropy cost function and neighbor information are introduced to guide the learning process. Although NMF can solve the high dimensional problem well, it seems to be useless in capturing the internal structure of data, so that the subsequent work achieves the purpose of retaining the local geometric structure of a data space by adding a graphic regularization item and a popular regularization item. In order to reduce the influence of outliers, the norm of manifold regularization must be introduced in the work. With the development of research, information extracted by single-layer NMF clustering often cannot meet the requirement of data information mining. In order to explore deeper latent information in data, a deep semi-NMF model is proposed in the prior art to explore complex hierarchical information with implicit low-level latent attributes. Under the influence of the deep semi-NMF, the model DMVC learns the common low-dimensional representation containing deep information through the guidance of the original data structure. Recently, a method of multi-view clustering by a deep NMF method has also been proposed to automatically learn the optimal weight of each view.

Current conventional existing NMF methods achieve a large increase in clustering performance by learning low-dimensional representations with rich information, however, they can still be improved with the following considerations. 1) The function of the original data is fully exerted to obtain more discrimination information; 2) the sharing between views and specific information between views is shared; 3) a strategy for fusion of multi-view information is improved.

### SUMMARY

For the defects of the prior art, an objective of the present application is to provide a multi-view clustering method and system based on matrix decomposition and multi-partition alignment.

In order to achieve the above objective, the present application uses the following technical solutions.

A multi-view clustering method based on matrix decomposition and multi-partition alignment includes:
S1: acquiring a clustering task and a target data sample;
S2: decomposing multi-view data corresponding to the acquired clustering task and the acquired target data sample through a multi-layer matrix to obtain a basic partition matrix of each view;
S3: fusing and aligning the obtained basic partition matrix of each view by using column transformation to obtain a consistent fused partition matrix;
S4: unifying the obtained basic partition matrix of each view and the consistent fused partition matrix, and constructing an objective function corresponding to the unified partition matrix;
S5: optimizing the constructed objective function by using an alternating optimization method to obtain an optimized unified partition matrix; and
S6: performing spectral clustering on the obtained optimized unified partition matrix to obtain a final clustering result.

Further, the constructing an objective function corresponding to the unified partition matrix in the step S4 is represented as:

$$min {\sum }_{v = 1}^{V} {( {α}^{( v )} )}^{2} {‖ {X}^{( v )} - {Z}_{1}^{( v )} {Z}_{2}^{( v )} L {Z}_{m}^{( v )} {H}_{m}^{( v )} ‖}_{F}^{2} - λtr ( H {\sum }_{v = 1}^{V} {β}^{( v )} {H}_{m}^{( v ) T} {W}^{( v )} )$$

$$s . t . {H}_{i}^{( v )} \geq 0 , {HH}^{T} = {I}_{k} , {W}^{( v )} {W}^{( v ) T} = {I}_{k} , {α}^{( v )} \geq 0 ,$$

$${\sum }_{v = 1}^{V} {α}^{( v )} = 1 , {β}^{( v )} \geq 0 , {\sum }_{v = 1}^{V} {β}^{{( v )}^{2}} V = 1$$

where α^{(v)} represents a weight for the v^{th} view; X^{(v)} represents a feature matrix of the v^{th} view; Zᵢ^{(v)} and Hᵢ^{(v)} represent the i^{th} layer base matrix of the v^{th} view; λ represents a balance coefficient of partition learning and fusion learning; Hₘ^{(v)}, W^{(v)}, and H represent a basic partition matrix, a column alignment matrix, and a consistent fused partition matrix of the v^{th} view, respectively; β^{(v)} represents a weight of the corresponding basic partition of the v^{th} view in a late fusion process; H^{T} represents a transpose of H; and W^{(v)T} represents a transpose of W^{(v)}.

Further, the optimizing the constructed objective function by using an alternating optimization method in the step S5 specifically includes:
A1: fixing variables Zᵢ^{(v)}, Hᵢ^{(v)}, Hₘ^{(v)}, W^{(v)}, β, and α^{(v)}, and optimizing H, where an optimization formula for H is represented as:

$$min - t r ( HU ) , s . t . {HH}^{T} = {I}_{k} where U = {\sum }_{v = 1}^{V} {β}^{( v )} {H}_{m}^{( v ) T} {W}^{( v )}$$

represents a partition matrix after fusion;
A2: fixing variables H, Hᵢ^{(v)}, W^{(v)}, β, and α^{(v)}, and optimizing Zᵢ^{(v)}, where an optimization formula for Zᵢ^{(v)} is represented as:

min∥X^{(v)}−ϕZᵢ^{(v)}Hᵢ^{(v)}∥_{F}²
where ϕ=Z₁^{(v)} Z₂^{(v)} . . . Zᵢ₋₁^{(v)} represents the multiplication of the first i−1^{th} base matrices;
A3: fixing variables Zᵢ^{(v)}, H, Hₘ^{(v)}, W^{(v)}, β, and α^{(v)}, and optimizing Hₘ^{(v)}, where an optimization formula for Hₘ^{(v)} is represented as:

min∥X^{(v)}−ΦHₘ^{(v)}∥_{F}²,s·t·Hᵢ^{(v)}≥0
where Φ=Z₁^{(v)} Z₂^{(v)} . . . Zᵢ^{(v)} represents the multiplication of the first i^{th} base matrices;
A4: fixing variables Zᵢ^{(v)}, Hᵢ^{(v)}, H, W^{(v)}, β, and α^{(v)}, and optimizing Hₘ^{(v)}, where an optimization formula for Hₘ^{(v)} is represented as:

min∥X^{(v)}−ΦHₘ^{(v)}∥_{F}²−λtr(Hβ^{(v)}Hₘ^{(v)T}W^{(v)}+G),s·t·Hₘ^{(v)}≥−0
where Φ=Z₁^{(v)}Z₂^{(v)} . . . Zₘ^{(v)} represents the multiplication of the first i^{th} base matrices; G=Σ_{o=1,o≈v}^{V}β^{(o)}Hₘ^{(o)T}W^{(o)} represents fusion of other basic partitions except for the partition matrix corresponding to the v^{th} view;
A5: fixing variables Zᵢ^{(v)}, Hᵢ^{(v)}, Hₘ^{(v)}, H, β, and α^{(v)} and optimizing W^{(v)}, where an optimization formula for W^{(v)} is represented as:

min−tr(W^{(v)T}Q),s·t·W^{(v)}W^{(v)T}=Iₖ
where Q=β^{(v)}Hₘ^{(v)T}H^{T} represents the product of the similarity of the v^{th} view and the corresponding weight;
A6: fixing variables Zᵢ^{(v)}, Hᵢ^{(v)}, Hₘ^{(v)}, W^{(v)}, β, and H, and optimizing α^{(v)}, where an optimization formula for α^{(v)} is represented as:

min(α^{(v)})²R^{(v)},s·t·α^{(v)}≥0,Σᵥ₌₁^{V}α^{(v)}=1
where R^{(v)}=∥X^{(v)}−Z₁^{(v)} Z₂^{(v)} . . . Zₘ^{(v)}Hₘ^{(v)}∥_{F}² represents reconstruction loss of the v^{th} view;
A7: fixing variables Zᵢ^{(v)}, Hᵢ^{(v)}, Hₘ^{(v)}, W^{(v)}, H, and α^{(v)}, and optimizing β, where an optimization formula for β is represented as:

$$max tr ( {\sum }_{v = 1}^{V} {β}^{( v )} {H}_{m}^{( v ) T} {W}^{( v )} H ) , s . t . {β}^{( v )} \geq 0 , {\sum }_{v = 1}^{V} {β}^{( v ) 2} = 1$$

the optimization formula of β is simplified as follows:

max f^{T}β,s·t·β≥0,β²^{^{T}}=1
where f^{T}=[f₁,f₂, . . . , f_{V}] represents a set of traces of similarity matrices of different views; and fᵥ=tr(Hₘ^{(v)T}W^{(v)}H) represents a trace of the similarity matrix of the v^{th} view.

Further, the steps A1, A2, A3, A4, and A5 all further include: obtaining an optimized result through singular value decomposition (SVD).

Further, the step A4 further includes:
constructing a Lagrangian function, and solving a Karush-Kuhn-Tucker (KKT) condition corresponding to the constructed Lagrangian function to obtain the update of Hₘ^{(v)}, which is represented as:

Hₘ^{(v)}=Hₘ^{(v)}⊗\sqrt{ [symbol]ᵤ(ZHW)/ [symbol] ₁(ZHW)}

[symbol]

ᵤ(ZHW)=2(α^{(v)})²([Φ^{T}X^{(v)}]⁺+[Φ^{T}ΦHₘ^{(v)}]⁻)+λβ^{(v)}[W^{(v)}H]⁺

[symbol]

₁(ZHW)=2(α^{(v)})²([Φ^{T}X^{(v)}]⁻+[Φ^{T}ΦHₘ^{(v)}]⁺)+λβ^{(v)}[W^{(v)}H]⁻
where [symbol] ᵤ(ZHW) represents a function for Z, H and W as a numerator of a formula; and [symbol] ₁(ZHW) represents a function for Z, H and W as a denominator of the formula.

Further, the step A6 further includes:
constructing a Lagrangian function, and solving a KKT condition corresponding to the constructed Lagrangian function to obtain the update of a^{(v)}, which is represented as:

α^{(v)}=Σᵥ₌₁^{V}R^{(v)}/R^{(v)}
where R^{(v)} represents reconstruction loss of the v^{th} view.

Further, the step A7 further includes:
obtaining a closed-form solution of the updated β according to the Cauchy-Bunyakovsky-Schwarz inequality, which is represented as:

β=f/\sqrt{Σf²}

where f represents a set of traces of similarity matrices of different views.

Correspondingly, further provided is a multi-view clustering system based on matrix decomposition and multi-partition alignment, which includes:
an acquisition module configured to acquire a clustering task and a target data sample;
a decomposition module configured to decompose multi-view data corresponding to the acquired clustering task and the acquired target data sample through a multi-layer matrix to obtain a basic partition matrix of each view;
a fusion module configured to fuse and align the obtained basic partition matrix of each view by using column transformation to obtain a consistent fused partition matrix;
a construction module configured to unify the obtained basic partition matrix of each view and the consistent fused partition matrix, and construct an objective function corresponding to the unified partition matrix;
an optimization module configured to optimize the constructed objective function by using an alternating optimization method to obtain an optimized unified partition matrix; and
a clustering module configured to perform spectral clustering on the obtained optimized unified partition matrix to obtain a final clustering result.

Further, the constructing an objective function corresponding to the unified partition matrix in the construction module is represented as:

$$\\ min {\sum }_{v = 1}^{V} {( {α}^{( v )} )}^{2} {‖ {X}^{( v )} - {Z}_{1}^{( v )} {Z}_{2}^{( v )} L {Z}_{m}^{( v )} {H}_{m}^{( v )} ‖}_{F}^{2} - λ tr ( H {\sum }_{v = 1}^{V} {β}^{( v )} {H}_{m}^{( v )} {W}^{( v )} )$$

$$\\ s . t . {H}_{i}^{( v )} \geq 0 , {HH}^{T} = {I}_{k} , {W}^{( v )} {W}^{( v ) T} = {I}_{k} , {α}^{( v )} \geq 0 ,$$

$$\\ {\sum }_{v = 1}^{V} {α}^{( v )} = 1 , {β}^{( v )} \geq 0 , {\sum }_{v = 1}^{V} {β}^{{( v )}^{2}} = 1$$

where a^{(v)} represents a weight for the v^{th} view; X^{(v)} represents a feature matrix of the v^{th} view; Zᵢ^{(v)} and Hᵢ^{(v)} represent the i^{th} layer base matrix of the v^{th} view; λ represents a balance coefficient of partition learning and fusion learning; Hₘ^{(v)}, W^{(v)}, and H represent a basic partition matrix, a column alignment matrix, and a consistent fused partition matrix of the v^{th} view, respectively; β^{(v)} represents a weight of the corresponding basic partition of the v^{th} view in a late fusion process; H^{T} represents a transpose of H; and W^{(v)T} represents a transpose of W^{(v)}.

Further, the optimizing the constructed objective function by using an alternating optimization method in the optimization module specifically includes:
fixing variables Zᵢ^{(v)}Hᵢ^{(v)}, Hₘ^{(v)}, W^{(v)}, β, and α^{(v)}, and optimizing H, where an optimization formula for H is represented as:

$$\\ min - tr ( HU ) , s . t . {HH}^{T} = {I}_{k} where U = {\sum }_{v = 1}^{V} {β}^{( v )} {H}_{m}^{( v ) T} {W}^{( v )}$$

represents a partition matrix after fusion;
fixing variables H, Hᵢ^{(v)}, Hₘ^{(v)}, W^{(v)}, β, and α^{(v)}, and optimizing Zᵢ^{(v)}, where an optimization formula for Zᵢ^{(v)} is represented as:

min∥X^{(v)}−ϕZᵢ^{(v)}Hᵢ^{(v)}∥_{F}²
where ϕ=Z₁^{(v)} Z₂^{(v)} . . . Zᵢ₋₁^{(v)} represents the multiplication of the first i−1^{th} base matrices; fixing variables Zᵢ^{(v)}, H, Hₘ^{(v)}, W^{(v)}, β, and α^{(v)}, and optimizing Hᵢ^{(v)}, where an optimization formula for Hᵢ^{(v)} is represented as:

min∥X^{(v)}−ΦHᵢ^{(v)}∥_{F}²,s·t·Hᵢ^{(v)}≥0
where Φ=Z₁^{(v)} Z₂^{(v)} . . . Zᵢ^{(v)} represents the multiplication of the first i^{th} base matrices; fixing variables Zᵢ^{(v)}, Hᵢ^{(v)}, H, W^{(v)}, β, and α^{(v)}, and optimizing Hₘ^{(v)}, where an optimization formula for Hₘ^{(v)} is represented as:

min∥X^{(v)}−ΦHₘ^{(v)}∥_{F}²−λtr(Hβ^{(v)}Hₘ^{(v)T}W^{(v)}+G),s·t·Hₘ^{(v)}≥0

where Φ=Z₁^{(v)} Z₂^{(v)} . . . Zₘ^{(v)} represents the multiplication of the first i^{th} base matrices; G=Σ_{o=1,o≈v}^{V}β^{(o)}Hₘ^{(o)T}W^{(o)} represents fusion of other basic partitions except for the partition matrix corresponding to the v^{th} view;
fixing variables Zᵢ^{(v)}, Hᵢ^{(v)}, Hₘ^{(v)}, H, β, and α^{(v)}, and optimizing W^{(v)}, where an optimization formula for W^{(v)} is represented as:

min−tr(W^{(v)T}Q),s·t·W^{(v)}W^{(v)T}=Iₖ
where Q=β^{(v)}Hₘ^{(v)T}H^{T} represents the product of the similarity of the v^{th} view and the corresponding weight;
fixing variables Zᵢ^{(v)} Hᵢ^{(v)}, Hₘ^{(v)}, W^{(v)}, β, and H, and optimizing α^{(v)}, where an optimization formula for α^{(v)} is represented as:

min(α^{(v)})²R^{(v)},s·t·α^{(v)}≥0,Σᵥ₌₁^{V}α^{(v)}=1
where R^{(v)}=∥X^{(v)}−Z₁^{(v)} Z₂^{(v)} . . . Zₘ^{(v)} Hₘ^{(v)} represents reconstruction loss of the v^{th} view;
fixing variables Zᵢ^{(v)}, Hᵢ^{(v)}, Hₘ^{(v)}, W^{(v)}, H, and α^{(v)}, and optimizing β, where an optimization formula for β is represented as:

$$\\ max tr ( {\sum }_{v = 1}^{V} {β}^{( v )} {H}_{m}^{( v ) T} {W}^{( v )} H ) , s . t . {β}^{( v )} \geq 0 , {\sum }_{v = 1}^{V} {β}^{( v ) 2} = 1$$

the optimization formula of β is simplified as follows:

max f^{T}β,s·t·β≥0,β²^{^{T}}=1
where f^{T}=[f₂,f₂, . . . , f_{V}] represents reconstruction loss of the v^{th} view; and fᵥ=tr(Hₘ^{(v)T}W^{(v)}H) represents a trace of the similarity matrix of the v^{th} view.

Compared with the prior art, the present application provides a novel conventional clustering method based on deep matrix decomposition and partition alignment, which includes the optimization objective of a basic partition learning module and a multi-partition fusion module. A large number of ablation experiments can show that the multi-partition fusion module added in the present application is beneficial to better fusion of information between views and can acquire richer information along with the increase of the number of layers. The experimental results on the six common datasets demonstrate that the performance of the present application is superior to that of the existing methods.

### BRIEF DESCRIPTION OF THE DRAWINGS

FIG. 1 is a flowchart of a multi-view clustering method based on matrix decomposition and multi-partition alignment according to Embodiment 1; and

FIG. 2 is a schematic diagram of the MVC-DMF-MPA framework according to Embodiment 1.

### DETAILED DESCRIPTION OF THE EMBODIMENTS

The following describes the embodiments of the present application by specific examples, and other advantages and effects of the present application will be readily apparent to those skilled in the art from the disclosure of the present application. The present application can also be implemented or applied through other different specific embodiments, and various modifications or changes can be made to the details in this specification based on different viewpoints and applications without departing from the spirit of the present application. It should be noted that the following embodiments and features in the embodiments can be combined with each other without conflict.

The conventional clustering method based on matrix decomposition only considers the common information among the views and ignores the specific information of the views, which results in insufficient representation learning and the possibility of noise doping in early fusion, and thus leading to inaccurate learning of results; aiming at the above problem, the present application provides a multi-view clustering method and system based on matrix decomposition and multi-partition alignment, where a basic partition matrix of each view is obtained through deep semi-nonnegative matrix factorization, then the fused partition matrix is obtained by combining the column-selected matrices of these basic partition matrices, and the common partition matrix is approximated to the fused partition matrix. The optimization is optimized through basis partitioning matrix and late fusion process. Finally, k-means clustering is performed by using the public partition to realize the purpose of clustering.

### Embodiment 1

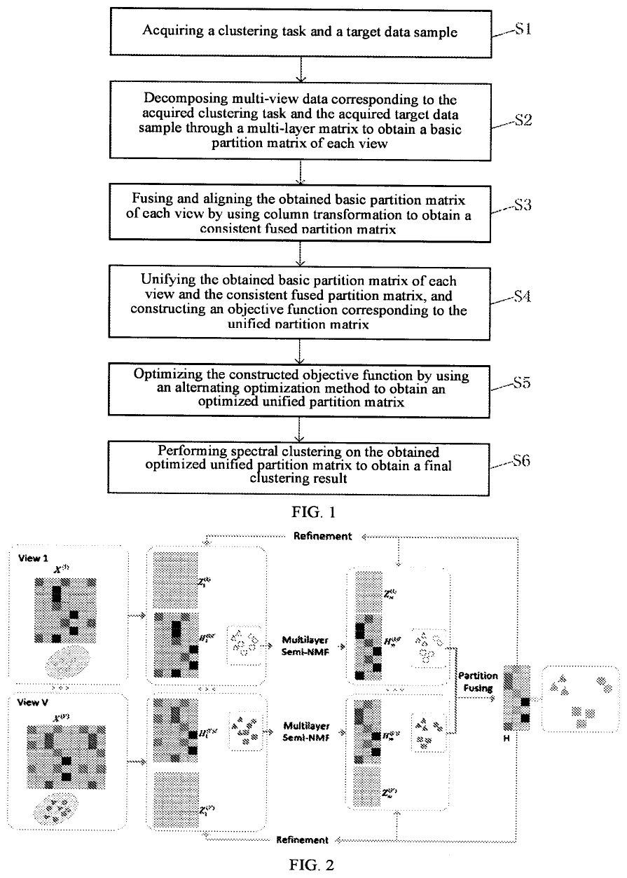

This embodiment provides a multi-view clustering method based on matrix decomposition and multi-partition alignment, as shown in FIG. 1, which includes:
S1: acquiring a clustering task and a target data sample;
S2: decomposing multi-view data corresponding to the acquired clustering task and the acquired target data sample through a multi-layer matrix to obtain a basic partition matrix of each view;
S3: fusing and aligning the obtained basic partition matrix of each view by using column transformation to obtain a consistent fused partition matrix;
S4: unifying the obtained basic partition matrix of each view and the consistent fused partition matrix, and constructing an objective function corresponding to the unified partition matrix;
S5: optimizing the constructed objective function by using an alternating optimization method to obtain an optimized unified partition matrix; and
S6: performing spectral clustering on the obtained optimized unified partition matrix to obtain a final clustering result.

This embodiment provides an unsupervised conventional clustering method based on matrix decomposition and late fusion, and as shown in FIG. 2, this method mainly includes two parts, namely a basic partition matrix learning module (multilayer semi-nonnegative matrix factorization) and late fusion.

In the step S4, the obtained basic partition matrix of each view and the consistent fused partition matrix are unified, and an objective function corresponding to the unified partition matrix is constructed.

In order to reduce the possibility of noise affecting the result, reduce time and improve efficiency, partition level, namely decision-level fusion is adopted. The partition matrix Hi of different views and the consistent fused partition matrix H are learned. The objective function is represented as:

$$\\ min {\sum }_{v = 1}^{V} {( {α}^{( v )} )}^{2} {‖ {X}^{( v )} - {Z}_{1}^{( v )} {Z}_{2}^{( v )} L {Z}_{m}^{( v )} {H}_{m}^{( v )} ‖}_{F}^{2} - λ tr ( H {\sum }_{v = 1}^{V} {β}^{( v )} {H}_{m}^{( v )} {W}^{( v )} )$$

$$\\ s . t . {H}_{i}^{( v )} \geq 0 , {HH}^{T} = {I}_{k} , {W}^{( v )} {W}^{( v ) T} = {I}_{k} , {α}^{( v )} \geq 0 ,$$

$$\\ {\sum }_{v = 1}^{V} {α}^{( v )} = 1 , {β}^{( v )} \geq 0 , {\sum }_{v = 1}^{V} {β}^{{( v )}^{2}} = 1$$

where a^{(v)} represents a weight for the v^{th} view; X^{(v)} represents a feature matrix of the v^{th} view; Zᵢ^{(v)} and Hᵢ^{(v)} represent the i^{th} layer base matrix of the v^{th} view; λ represents a balance coefficient of partition learning and fusion learning; Hₘ^{(v)}, W^{(v)}, and H represent a basic partition matrix, a column alignment matrix, and a consistent fused partition matrix of the v^{th} view, respectively; β^{(v)} represents a weight of the corresponding basic partition of the v^{th} view in a late fusion process; H^{T} represents a transpose of H; and W^{(v)T} represents a transpose of W^{(v)}. ∥⋅∥_{F} represents F norm.

The above formula obtains the partition of each view through deep nonnegative matrix factorization, and in the subsequent steps, the partition of each view is column-selected to approach a unified partition matrix, and finally the unified partition matrix is used for clustering.

In the step S5, the constructed objective function is constructed by using an alternating optimization method to obtain an optimized unified partition matrix.

The optimization problem of the objective function is difficult to solve directly, so an iterative algorithm is provided to effectively solve the optimization problem.

The step specifically includes:
A1: fixing variables Zᵢ^{(v)}, Hᵢ^{(v)}, Hₘ^{(v)}, W^{(v)}, β, and α^{(v)}, and optimizing H, where an optimization formula for H is represented as:

min−tr(HU),s·t·HH^{T}=Iₖ

where tr( ) represents a trace;

$$\\ U = {\sum }_{v = 1}^{V} {β}^{( v )} {H}_{m}^{( v ) T} {W}^{( v )}$$

represents the fused partition matrix; and U can be directly decomposed by SVD to obtain the optimized H.
A2: fixing variables H, Hᵢ^{(v)}, Hₘ^{(v)}, W^{(v)}, β, and α^{(v)}, and optimizing Zᵢ^{(v)}, where an optimization formula for Zᵢ^{(v)} is represented as:

min∥X^{(v)}−ϕZᵢ^{(v)}Hᵢ^{(v)}∥_{F}²

where ϕ=Z₁^{(v)}Z₂^{(v)} . . . Zᵢ₋₁^{(v)} represents the multiplication of the first i−1^{th} base matrices; and φ can be directly decomposed by SVD to obtain the optimized Zᵢ^{(v)}.
A3: fixing variables Zᵢ^{(v)}, H, Hₘ^{(v)}, W^{(v)}, β, and α^{(v)}, and optimizing Hᵢ^{(v)}, where an optimization formula for Hᵢ^{(v)} is represented as:

min∥X^{(v)}−ΦHᵢ^{(v)}∥_{F}²,s·t·Hᵢ^{(v)}≥0

where Φ=Zᵢ^{(v)}Z₂^{(v)} . . . Zᵢ^{(v)} represents the multiplication of the first i−1^{th} base matrices; and Φ can be directly decomposed by SVD to obtain the optimized Hᵢ^{(v)}.
A4: fixing variables Zᵢ^{(v)}, Hᵢ^{(v)}, H, W^{(v)}, β, and α^{(v)}, and optimizing Hₘ^{(v)}, where an optimization formula for Hₘ^{(v)}is represented as:

min∥X^{(v)}−ΦHₘ^{(v)}∥_{F}²−λtr(Hβ^{(v)}Hₘ^{(v)T}W^{(v)}+G),s·t·Hₘ^{(v)}≥0
where Φ=Z₁^{(v)}Z₂^{(v)} . . . Zₘ^{(v)} represents the multiplication of the first i^{th} base matrices; G=Σ_{o=1,o≈v}^{V}β^{(o)}Hₘ^{(o)T}W^{(o)} represents fusion of other basic partitions except for the partition matrix corresponding to the v^{th} view; Φ and G can be directly decomposed by SVD to obtain the optimized Hₘ^{(v)}.

The step further includes:
constructing a Lagrangian function, and solving a KKT condition corresponding to the constructed Lagrangian function to obtain the update of Hₘ^{(v)}, which is represented as:

Hₘ^{(v)}=Hₘ^{(v)⊗} [symbol] ᵤ(ZHW)/ [symbol] _{I}(ZHW)

[symbol]

ᵤ(ZHW)=2(α^{(v)})²([Φ^{T}X^{(v)}]⁺+[Φ^{T}ΦHₘ^{(v)}]⁻)+λβ^{(v)}[W^{(v)}H]⁺

[symbol]

₁(ZHW)=2(α^{(v)})²([Φ^{T}X^{(v)}]⁻+[Φ^{T}ΦHₘ^{(v)}]⁺)+λβ^{(v)}[W^{(v)}H]⁻
where [ ]⁺ represents a positive part; [ ]⁻ represents the negative part; [symbol] ᵤ(ZHW) represents a function for Z, H and W as a numerator of a formula; and [symbol] ₁(ZHW) represents a function for Z, H and W as a denominator of the formula.
A5: fixing variables Zᵢ^{(v)}, Hᵢ^{(v)}, Hₘ^{(v)}, H, β, and α^{(v)}, and optimizing W^{(v)}, where an optimization formula for W^{(v)} is represented as:

min−tr(W^{(v)T}Q),s·t·W^{(v)}W^{(v)T}=Iₖ
where Q=β^{(v)}Hₘ^{(v)T}H^{T} represents the product of the similarity of the v^{th} view and the corresponding weight; and Q can be directly decomposed through SVD to obtain the optimized W^{(v)}.
A6: fixing variables Zᵢ^{(v)}, Hᵢ^{(v)}, Hₘ^{(v)}, W^{(v)}, β, and H, and optimizing α^{(v)}, where an optimization formula for α^{(v)} is represented as:

min(α^{(v)})²R^{(v)},s·t·α^{(v)}≥0,Σᵥ₌₁^{V}α^{(v)}=1
where R^{(v)}=∥X^{(v)}−Z₁^{(v)}Z₂^{(v)} . . . Zₘ^{(v)}Hₘ^{(v)}∥_{F}² represents reconstruction loss of the v^{th} view. constructing a Lagrangian function, and solving a KKT condition corresponding to the constructed Lagrangian function to obtain the update of a^{(v)}, which is represented as:

α^{(v)}=Σᵥ₌₁^{V}R^{(v)}/R^{(v)}
where R^{(v)} represents reconstruction loss of the v^{th} view.
A7: fixing variables Zᵢ^{(v)}, Hᵢ^{(v)}, Hₘ^{(v)}, W^{(v)}, H, and α^{(v)}, and optimizing β, where an optimization formula for β is represented as:

$$\\ max tr ( {\sum }_{v = 1}^{V} {β}^{( v )} {H}_{m}^{( v ) T} {W}^{( v )} H ) , s . t . {β}^{( v )} \geq 0 , {\sum }_{v = 1}^{V} {β}^{( v ) 2} = 1$$

the optimization formula of β is simplified as follows:

max f^{T}β,s·t·β≥0,β²^{^{T}}=1
where f^{T}=[f₁, f₂, . . . , f_{V}] represents a set of traces of similarity matrices of different views; and fᵥ=tr(Hₘ^{(v)T}W^{(v)}H) represents a trace of the similarity matrix of the v^{th} view. obtaining a closed-form solution of the updated β according to the Cauchy-Bunyakovsky-Schwarz inequality, which is represented as:

β=f/\sqrt{Σf²}
where f represents a set of traces of similarity matrices of different views.

In summary, the objective function value monotonically decreases as the above stepwise optimization is performed alternately. Meanwhile, the objective function has a lower bound. Thus, the above optimization process can ensure convergence. In addition, a multi-view clustering algorithm based on nonnegative matrix factorization and multi-partition alignment is proposed, which unifies the clustering process and fusion process in one framework. The learning of the consistent partition matrix is more suitable for clustering, so that the algorithm can achieve a better clustering effect.

The difference between this embodiment and the prior art is that:

(1) A multi-view clustering method based on deep semi-NMF and multi-partition alignment is provided. The basic partition learning and the late fusion stage are unified into a framework, enabling them to promote and guide each other to obtain the final common partition matrix for clustering.

(2) The feature matrix is first decomposed using a depth semi-NMF framework to obtain a base partition matrix of each view. Then the basic partition matrices are fused by adopting a late fusion mode, and finally the alignment of the fused basic partition matrix and the public partition matrix is maximized to obtain a public partition matrix.

(3) An alternating optimization algorithm is designed to solve the optimization problem and extensive experiments are performed on the six multi-view datasets.

This embodiment provides a novel conventional clustering method based on deep matrix decomposition and partition alignment, which includes the optimization objective of a basic partition learning module and a multi-partition fusion module. A large number of ablation experiments can show that the multi-partition fusion module added in this embodiment is beneficial to better fusion of information between views and can acquire richer information along with the increase of the number of layers.

Correspondingly, further provided is a multi-view clustering system based on matrix decomposition and multi-partition alignment, which includes:
an acquisition module configured to acquire a clustering task and a target data sample;
a decomposition module configured to decompose multi-view data corresponding to the acquired clustering task and the acquired target data sample through a multi-layer matrix to obtain a basic partition matrix of each view;
a fusion module configured to fuse and align the obtained basic partition matrix of each view by using column transformation to obtain a consistent fused partition matrix;
a construction module configured to unify the obtained basic partition matrix of each view and the consistent fused partition matrix, and construct an objective function corresponding to the unified partition matrix;
an optimization module configured to optimize the constructed objective function by using an alternating optimization method to obtain an optimized unified partition matrix; and
a clustering module configured to perform spectral clustering on the obtained optimized unified partition matrix to obtain a final clustering result.

Further, the constructing an objective function corresponding to the unified partition matrix in the construction module is represented as:

$$\\ min {\sum }_{v = 1}^{V} {( {α}^{( v )} )}^{2} {‖ {X}^{( v )} - {Z}_{1}^{( v )} {Z}_{2}^{( v )} L {Z}_{m}^{( v )} {H}_{m}^{( v )} ‖}_{F}^{2} - λ tr ( H {\sum }_{v = 1}^{V} {β}^{( v )} {H}_{m}^{( v )} {W}^{( v )} )$$

$$\\ s . t . {H}_{i}^{( v )} \geq 0 , {HH}^{T} = {I}_{k} , {W}^{( v )} {W}^{( v ) T} = {I}_{k} , {α}^{( v )} \geq 0 ,$$

$$\\ {\sum }_{v = 1}^{V} {α}^{( v )} = 1 , {β}^{( v )} \geq 0 , {\sum }_{v = 1}^{V} {β}^{{( v )}^{2}} = 1$$

where α^{(v)} represents a weight for the v^{th} view; X^{(v)} represents a feature matrix of the v^{th} view; Zᵢ^{(v)} and Hᵢ^{(v)} represent the i^{th} layer base matrix of the v^{th} view; λ represents a balance coefficient of partition learning and fusion learning; Hₘ^{(v)}, W^{(v)}, and H represent a basic partition matrix, a column alignment matrix, and a consistent fused partition matrix of the v^{th} view, respectively; β^{(v)} represents a weight of the corresponding basic partition of the v^{th} view in a late fusion process; H^{T} represents a transpose of H; and W^{(v)T} represents a transpose of W^{(v)}.

Further, the optimizing the constructed objective function by using an alternating optimization method in the optimization module specifically includes:
fixing variables Zᵢ^{(v)}, Hᵢ^{(v)}, Hₘ^{(v)}, W^{(v)}, β, and α^{(v)}, and optimizing H, where an optimization formula for H is represented as:

$$\\ min - tr ( HU ) , s . t . {HH}^{T} = {I}_{k} where U = {\sum }_{v = 1}^{V} {β}^{( v )} {H}_{m}^{( v ) T} {W}^{( v )}$$

represents a partition matrix after fusion;
fixing variables H, Hᵢ^{(v)}, Hₘ^{(v)}, W^{(v)}, β, and α^{(v)}, and optimizing Zᵢ^{(v)}, where an optimization formula for Zᵢ^{(v)} is represented as:

min∥X^{(v)}−ϕZᵢ^{(v)}Hᵢ^{(v)}∥_{F}²
where ϕ=Z₁^{(v)}Z₂^{(v)} . . . Zᵢ₋₁^{(v)} represents the multiplication of the first i−1^{th} base matrices;
fixing variables Zᵢ^{(v)}, H, Hₘ^{(v)}, W^{(v)}, β, and α^{(v)}, and optimizing Hᵢ^{(v)}, where an optimization formula for Hᵢ^{(v)} is represented as:

min∥X^{(v)}−ΦHᵢ^{(v)}∥_{F}²,s·t·Hᵢ^{(v)}≥0
where Φ=Z₁^{(v)}Z₂^{(v)} . . . Zᵢ^{(v)} represents the multiplication of the first i^{th} base matrices;
fixing variables Zᵢ^{(v)}, Hᵢ^{(v)}), H, W^{(v)}, β, and α^{(v)}, and optimizing Hₘ^{(v)}, where an optimization formula for Hₘ^{(v)} is represented as:

min∥X^{(v)}−ΦHₘ^{(v)}∥_{F}²−λtr(Hβ^{(v)}Hₘ^{(v)T}W^{(v)}+G),s·t·Hₘ^{(v)}≥0
where Φ=Z₁^{(v)}Z₂^{(v)} . . . Zₘ^{(v)} represents the multiplication of the first i^{th} base matrices; G=Σ_{o=1,o≈v}^{V}β^{(o)}Hₘ^{(o)T}W^{(o)} represents fusion of other basic partitions except for the partition matrix corresponding to the v^{th} view;
fixing variables Zᵢ^{(v)}, Hᵢ^{(v)}, Hₘ^{(v)}, H, β, and α^{(v)}, and optimizing W^{(v)}, where an optimization formula for W^{(v)} is represented as:

min−tr(W^{(v)T}Q),s·t·W^{(v)}W^{(v)T}=Iₖ
where Q=β^{(v)}Hₘ^{(v)T}H^{T} represents the product of the similarity of the v^{th} view and the corresponding weight;
fixing variables Zᵢ^{(v)}, Hᵢ^{(v)}, Hₘ^{(v)}, W^{(v)}, β, and H, and optimizing α^{(v)}, where an optimization formula for α^{(v)} is represented as:

min(α^{(v)})²R^{(v)},s·t·α^{(v)}≥0,Σᵥ₌₁^{V}α^{(v)}=1
where R^{(v)}=∥X^{(v)}−Z₁^{(v)}Z₂^{(v)} . . . Zₘ^{(v)}Hₘ^{(v)}∥_{F}² represents reconstruction loss of the v^{th} view;
fixing variables Zᵢ^{(v)}, Hᵢ^{(v)}, Hₘ^{(v)}, W^{(v)}, H, and α^{(v)}, and optimizing β, where an optimization formula for β is represented as:

$$\\ max tr ( {\sum }_{v = 1}^{V} {β}^{( v )} {H}_{m}^{( v ) T} {W}^{( v )} H ) , s . t . {β}^{( v )} \geq 0 , {\sum }_{v = 1}^{V} {β}^{( v ) 2} = 1$$

the optimization formula of β is simplified as follows:

max f^{T}β,s·t·β≥0,β²^{^{T}}=1
where f^{T}=[f₁, f₂, . . . , f_{V}] represents a set of traces of similarity matrices of different views; and fᵥ=tr(Hₘ^{(v)T}W^{(v)}H) represents a trace of the similarity matrix of the v^{th} view.

### Embodiment 2

The difference between the multi-view clustering method based on matrix decomposition and multi-partition alignment provided by this embodiment and Embodiment 1 is as follows:
this embodiment may be applied to image datasets or non-image datasets,
S1: acquiring a clustering task and a target data sample corresponding to an image dataset or non-image dataset;
S2: decomposing multi-view data corresponding to the acquired clustering task and the acquired target data sample through a multi-layer matrix to obtain a basic partition matrix of each view;
S3: fusing and aligning the obtained basic partition matrix of each view by using column transformation to obtain a consistent fused partition matrix;
S4: unifying the obtained basic partition matrix of each view and the consistent fused partition matrix, and constructing an objective function corresponding to the unified partition matrix;
S5: optimizing the constructed objective function by using an alternating optimization method to obtain an optimized unified partition matrix; and
S6: performing spectral clustering on the obtained optimized unified partition matrix to obtain a final clustering result.

The image dataset may include face images, images during logistics transportation, medical images, and the like; and the non-image dataset includes a text dataset and the like.

This embodiment verifies this method by means of six data.

There are six datasets used in this embodiment, including three graph datasets and three non-graph datasets, and the statistics of the datasets are shown in Table 1.

TABLE 1
Datasets

| | | | | Number | Number |
|---|---|---|---|---|---|
| | | Number | | of | of |
| Dataset | Type | of views | View dimension | samples | clusters |
| BBC | text | 4 | 4659 4633 4665 4684 | 685 | 5 |
| BBCSport | text | 2 | 3183 3203 | 544 | 5 |
| MSRCV1 | image | 5 | 1302 512 100 256 210 | 210 | 7 |
| ORL | image | 3 | 4096 3304 6750 | 400 | 40 |
| Reuters | text | 5 | 2000 2000 2000 | 1200 | 6 |
| | | | 2000 2000 | | |
| HW | image | 2 | 240 216 | 2000 | 10 |

BBC: This dataset is of the text type, and includes 685 samples distributed in 5 categories. This dataset has 4 views, and the dimensions of the four views are 4659, 4633, 4665, and 4684, respectively.
BBCSport: This dataset is of the text type, and includes 544 pieces of text data which are distributed in 5 categories. This dataset has 2 views, and the dimensions of the two views are 3183 and 3203, respectively.
MSRCV1: This dataset is of the image type, and includes 210 pieces of text data which are distributed in 3 categories. This dataset has 5 views, and the dimensions of the five views are 1302, 512, 100, 256, and 210, respectively.
ORL: This dataset is of the image type, and includes 400 pictures distributed in 40 categories. This dataset has 3 views, and the dimensions of the three views are 4096, 3304, and 6750, respectively.
Reuters: This dataset is of the text type, and includes 1200 pieces of text data which are distributed in 6 categories. This dataset has 5 views, and the dimensions of the five views are 2000, 2000, 2000, 2000, and 2000, respectively.
HW: This dataset is of the picture type, and includes 2000 images distributed in 10 categories. This dataset has 2 views, and the dimensions of the two views are 240 and 216, respectively.

This method is compared with 12 benchmark algorithms. The contrastive algorithm includes k-means used as input after view features are spliced, a kernel-based method MVKKM, a graph-based method GMC, two subspace-based PMSC and CSMCSC, two co-training methods Co-train and Co-reg, and five matrix decomposition-based models MultiNMF, MVCF, ScaMVC, DMVC, and AwDMVC.

Experiment Setting:

For this method and all contrastive methods, data preprocessing, i.e., normalization of all datasets, was performed first. The weighting coefficient γ was selected from [2-12, 2-11, . . . 24, 25]. This method considered that the cluster number k was the number of real classes of each dataset and the dimension of each layer in the decomposition process was related to the cluster number, therefore, two schemes were designed: a two-layer dimension p2=[11,k], and another layer dimension p3=[11,12,k]. The 11 in p2 was selected from [4k, 5k, 6k], and 11, 12 in p3 were selected from [8k, 10k, 12k] and [4k, 5k, 6k], respectively. This method repeated each experiment 50 times to avoid the effects of random initialization and to preserve the optimal results. All experiments were performed on a desktop computer configured as Intel i9-9900K CPU@ 3.60 GHz×16 and 64 GB memory.

Evaluation Indicators:

This method uses three evaluation indicators recognized in the field of conventional clustering algorithms: clustering accuracy (ACC), standard mutual information (NMI), and purity (PUR).

Experiment Results:

This method is compared with 12 benchmark algorithms on 6 standard datasets, and the result is shown in Table 2, where Table 2 is the comparison of this method with other deep clustering methods, and the best result is marked in bold. Table 3 shows the incremental values of the three different indicators over the second-best method on the six datasets. From these tables, the following conclusions are as follows: 1) Table 3 shows the increment values of the three different indicators over the second-best method on six datasets, and the increment values of ACC, NMI and Purity were 11.68%, 15.55% and 3.47% respectively in BBC data; the improvement values were 19.85%, 11.31%, and 17.46% on BBCSport data; for NMI in Retuers and HW, although the performance was reduced by 2.28% and 4.59% over that in the second round, the difference was small. In conclusion, this method outperforms these baseline algorithms on six benchmarks. 2) It was found that the best results were always obtained with this method, compared with DMVC and AwDMVC that also use the deep semi-NM/F framework strong baseline. This indicates that the late fusion strategy of this method is more efficient and robust for these datasets. 3) Compared with PMSC that performs graphic fusion firstly and then performs spectral clustering before later fusion, the method has more advantages. This further indicates that multi-layer semi-NMF can extract more latent useful information.

TABLE 2

| | | | | | | | |
|---|---|---|---|---|---|---|---|
| | | Co- | Co- | | Multi | | |
| Dataset | CKM | train | reg | MVKKM | NMF | DMVC | MVCF |

ACC

| | | | | | | | |
|---|---|---|---|---|---|---|---|
| BBC | 0.4036 | 0.3271 | 0.4061 | 0.4492 | 0.4826 | 0.4948 | 0.6575 |
| BBCSport | 0.4797 | 0.3918 | 0.2962 | 0.4045 | 0.5751 | 0.4381 | 0.6324 |
| MSRCV1 | 0.3238 | 0.8114 | 0.8110 | 0.6905 | — | 0.4048 | 0.8952 |
| ORL | 0.5825 | 0.7250 | 0.8325 | 0.6250 | 0.2375 | 0.7700 | 0.6650 |
| Reuters | 0.3900 | 0.5268 | 0.4699 | 0.2208 | 0.3633 | 0.3233 | 0.1675 |
| HW | 0.6490 | 0.8015 | 0.8204 | 0.6190 | 0.7854 | 0.3870 | 0.1005 |
| Average | 8.17 | 6.33 | 5.83 | 8.50 | 7.33 | 7.17 | 6.50 |
| Rank | | | | | | | |

NMI

| | | | | | | | |
|---|---|---|---|---|---|---|---|
| BBC | 0.2206 | 0.1094 | 0.1128 | 0.2096 | 0.2737 | 0.2016 | 0.4280 |
| BBCSport | 0.2764 | 0.1648 | 0.1318 | 0.1909 | 0.3796 | 0.2604 | 0.4045 |
| MSRCV1 | 0.7564 | 0.7434 | 0.7293 | 0.5672 | — | 0.2200 | 0.8137 |
| ORL | 0.7722 | 0.8661 | 0.9106 | 0.7797 | 0.3798 | 0.8800 | 0.8102 |
| Reuters | 0.3942 | 0.3129 | 0.2720 | 0.1035 | 0.3220 | 0.1348 | 0.0306 |
| HW | 0.6223 | 0.7659 | 0.7626 | 0.6564 | 0.7464 | 0.3865 | 0.0045 |
| Average | 6.00 | 6.17 | 6.67 | 8.00 | 7.33 | 8.00 | 6.67 |
| Rank | | | | | | | |

PUR

| BBC | 0.4063 | 0.3315 | 0.3424 | 0.4635 | 0.4825 | 0.4838 | 0.6584 |
|---|---|---|---|---|---|---|---|
| BBCSport | 0.4936 | 0.4368 | 0.3631 | 0.3761 | 0.5923 | 0.5136 | 0.6342 |
| MSRCV1 | 0.8524 | 0.8271 | 0.8238 | 0.6905 | — | 0.4190 | 0.8952 |
| ORL | 0.6300 | 0.7668 | 0.8500 | 0.6850 | 0.2375 | 0.7975 | 0.6850 |
| Reuters | 0.5458 | 0.5378 | 0.4816 | 0.2633 | 0.4533 | 0.3358 | 0.1708 |
| HW | 0.6830 | 0.8092 | 0.8258 | 0.6550 | 0.7981 | 0.3860 | 0.2000 |
| Average | 6.67 | 6.50 | 6.67 | 9.00 | 8.00 | 7.33 | 6.67 |
| Rank | | | | | | | |
| Dataset | ScaMVC | GMC | AwDMVC | CSMVSC | PMSC | OURS | |

ACC

| | | | | | | |
|---|---|---|---|---|---|---|
| BBC | 0.5195 | 0.6934 | 0.6504 | 0.4745 | 0.3664 | 0.8102 |
| BBCSport | 0.4367 | 0.7390 | 0.7076 | 0.4651 | 0.3750 | 0.9375 |
| MSRCV1 | 0.4190 | 0.8952 | — | 0.3524 | 0.3238 | 0.9143 |
| ORL | 0.6175 | 0.6325 | 0.1200 | 0.2275 | 0.1850 | 0.8675 |
| Reuters | 0.1625 | 0.1992 | 0.3408 | 0.2575 | 0.1692 | 0.5908 |
| HW | 0.7520 | 0.7610 | 0.2875 | 0.8065 | 0.6515 | 0.8690 |
| Average | 8.17 | 4.67 | 8.33 | 7.67 | 10.83 | 1.00 |
| Rank | | | | | | |

NMI

| | | | | | | |
|---|---|---|---|---|---|---|
| BBC | 0.2018 | 0.4852 | 0.4574 | 0.1828 | 0.0555 | 0.6406 |
| BBCSport | 0.2036 | 0.7047 | 0.4682 | 0.1224 | 0.0278 | 0.8178 |
| MSRCV1 | 0.6537 | 0.8189 | — | 0.1898 | 0.2681 | 0.8536 |
| ORL | 0.7892 | 0.8035 | 0.4343 | 0.3837 | 0.3553 | 0.9284 |
| Reuters | 0.0306 | 0.0820 | 0.3056 | 0.0803 | 0.0042 | 0.3715 |
| HW | 0.7564 | 0.8118 | 0.6293 | 0.7568 | 0.6165 | 0.7658 |
| Average | 7.83 | 3.67 | 7.00 | 9.83 | 12.00 | 1.50 |
| Rank | | | | | | |

PUR

| | | | | | | |
|---|---|---|---|---|---|---|
| BBC | 0.5256 | 0.6934 | 0.7755 | 0.4876 | 0.3693 | 0.8102 |
| BBCSport | 0.4426 | 0.7629 | 0.6599 | 0.4779 | 0.3805 | 0.9375 |
| MSRCV1 | 0.7429 | 0.8952 | — | 0.3619 | 0.3333 | 0.9143 |
| ORL | 0.6600 | 0.7150 | 0.1200 | 0.2975 | 0.2400 | 0.8875 |
| Reuters | 0.1708 | 0.2417 | 0.4875 | 0.2675 | 0.1708 | 0.5908 |
| HW | 0.7520 | 0.7825 | 0.5345 | 0.8175 | 0.6625 | 0.8690 |
| Average | 7.83 | 4.67 | 7.50 | 7.50 | 10.67 | 1.00 |
| Rank | | | | | | |

TABLE 3

| Metric | BBC | BBCSport | MSRCV1 | ORL | Reuters | HW |
|---|---|---|---|---|---|---|
| ACC | 11.68% | 19.85% | 1.90% | 3.50% | 6.40% | 4.86% |
| NMI | 15.55% | 11.31% | 3.47% | 1.78% | −2.28% | −4.59% |
| PUR | 3.47% | 17.46% | 1.90% | 3.75% | 4.50% | 4.33% |

The experimental results on the six common datasets of this embodiment demonstrate that the performance of the present application is superior to that of the existing methods.

It should be noted that the foregoing are merely some embodiments of the present application and applied technical principles. Those skilled in the art may understand that the present application is not limited to specific embodiments described herein, and those skilled in the art may make various significant changes, readjustments, and replacements without departing from the protection scope of the present application. Therefore, although the present application is described in detail by using the foregoing embodiments, the present application is not limited to the foregoing embodiments, and may further include more other equivalent embodiments without departing from the concept of the present application. The scope of the present application is determined by the scope of the appended claims.

What is claimed is:

1. A multi-view clustering method based on matrix decomposition and multi-partition alignment, comprising:
S1: acquiring a clustering task and a target data sample;
S2: decomposing multi-view data corresponding to the acquired clustering task and the acquired target data sample through a multi-layer matrix to obtain a basic partition matrix of each view;
S3: fusing and aligning the obtained basic partition matrix of each view by using column transformation to obtain a consistent fused partition matrix;
S4: unifying the obtained basic partition matrix of each view and the consistent fused partition matrix, and constructing an objective function corresponding to a unified partition matrix;
S5: optimizing the constructed objective function by using an alternating optimization method to obtain an optimized unified partition matrix; and
S6: performing spectral clustering on the obtained optimized unified partition matrix to obtain a final clustering result.

2. The multi-view clustering method according to claim 1, wherein the operation of constructing the objective function corresponding to the unified partition matrix in the step S4 is represented as:
$$\\ min {\sum }_{v = 1}^{V} {( {α}^{( v )} )}^{2} {‖ {X}^{( v )} - {Z}_{1}^{( v )} {Z}_{2}^{( v )} L {Z}_{m}^{( v )} {H}_{m}^{( v )} ‖}_{F}^{2} - λ tr ( H {\sum }_{v = 1}^{V} {β}^{( v )} {H}_{m}^{( v )} {W}^{( v )} )$$
$$\\ s . t . {H}_{i}^{( v )} \geq 0 , {HH}^{T} = {I}_{k} , {W}^{( v )} {W}^{( v ) T} = {I}_{k} , {α}^{( v )} \geq 0 ,$$
$$\\ {\sum }_{v = 1}^{V} {α}^{( v )} = 1 , {β}^{( v )} \geq 0 , {\sum }_{v = 1}^{V} {β}^{{( v )}^{2}} = 1$$
wherein α^{(v)} represents a weight for a v^{th} view; X^{(v)} represents a feature matrix of the v^{th} view; Zᵢ^{(v)} and Hᵢ^{(v)} represent an i^{th} layer base matrix of the v^{th} view; λ represents a balance coefficient of partition learning and fusion learning; Hₘ^{(v)}, W^{(v)}, and H represent a basic partition matrix, a column alignment matrix, and a consistent fused partition matrix of the v^{th} view, respectively; β^{(v)} represents a weight of the corresponding basic partition of the v^{th} view in a late fusion process; H^{T} represents a transpose of H; and W^{(v)T} represents a transpose of W^{(v)}.

3. The multi-view clustering method according to claim 2, wherein the operation of optimizing the constructed objective function by using the alternating optimization method in the step S5 comprises:
A1: fixing variables Zᵢ^{(v)}, Hᵢ^{(v)}, Hₘ^{(v)}, W^{(v)}, β, and α^{(v)}, and optimizing H, wherein an optimization formula for H is represented as:
$$\\ min - tr ( HU ) , s . t . {HH}^{T} = {I}_{k} wherein U = {\sum }_{v = 1}^{V} {β}^{( v )} {H}_{m}^{( v ) T} {W}^{( v )}$$
represents a partition matrix after fusion;
A2: fixing variables H, Hᵢ^{(v)}, Hₘ^{(v)}, W^{(v)}, β, and α^{(v)}, and optimizing Zᵢ^{(v)}, wherein an optimization formula for Zᵢ^{(v)} is represented as:
min∥X^{(v)}−ϕZᵢ^{(v)}Hᵢ^{(v)}∥_{F}²
wherein ϕ=Z₁^{(v)}Z₂^{(v)} . . . Zᵢ₋₁^{(v)} represents a multiplication of first i−1^{th} base matrices;
A3: fixing variables Zᵢ^{(v)}, H, Hₘ^{(v)}, W^{(v)}, β, and α^{(v)}, and optimizing Hᵢ^{(v)}, wherein an optimization formula for Hᵢ^{(v)} is represented as:
min∥X^{(v)}−ΦHᵢ^{(v)}∥_{F}²,s·t·Hᵢ^{(v)}≥0
wherein Φ=Z₁^{(v)}Z₂^{(v)} . . . Zᵢ^{(v)} represents a multiplication of first i^{th} base matrices;
A4: fixing variables Zᵢ^{(v)}, Hᵢ^{(v)}, H, W^{(v)}, β, and α^{(v)}, and optimizing Hₘ^{(v)}, wherein an optimization formula for Hₘ^{(v)} is represented as:
min∥X^{(v)}−ΦHₘ^{(v)}∥_{F}²−λtr(Hβ^{(v)}Hₘ^{(v)T}W^{(v)}+G),s·t·Hₘ^{(v)}≥0
wherein Φ=Z₁^{(v)}Z₂^{(v)} . . . Zₘ^{(v)} represents the multiplication of the first i^{th} base matrices; G=Σ_{o=1,o≈v}^{V}β^{(o)}Hₘ^{(o)T}W^{(o)} represents fusion of other basic partitions except for the partition matrix corresponding to the v^{th} view;
A5: fixing variables Zᵢ^{(v)}, Hᵢ^{(v)}, Hₘ^{(v)}, H, β, and α(v), and optimizing W^{(v)}, wherein an optimization formula for W^{(v)} is represented as:
min−tr(W^{(v)T}Q),s·t·W^{(v)}W^{(v)T}=Iₖ
wherein Q=β^{(v)}Hₘ^{(v)T}H^{T} represents a product of a similarity of the v^{th} view and the corresponding weight;
A6: fixing variables Zᵢ^{(v)}, Hᵢ^{(v)}, Hₘ^{(v)}, W^{(v)}, β, and H, and optimizing α^{(v)}, wherein an optimization formula for α^{(v)} is represented as:
min(α^{(v)})²R^{(v)},s·t·α^{(v)}≥0,Σᵥ₌₁^{V}α^{(v)}=1
wherein R^{(v)}=∥X^{(v)}−Z₁^{(v)}Z₂^{(v)} . . . Zₘ^{(v)}Hₘ^{(v)}∥_{F}² represents a reconstruction loss of the v^{th} view;
A7: fixing variables Zᵢ^{(v)}, Hᵢ^{(v)}, Hₘ^{(v)}, W^{(v)}, H, and α^{(v)}, and optimizing β, wherein an optimization formula for β is represented as:
$$\\ max tr ( {\sum }_{v = 1}^{V} {β}^{( v )} {H}_{m}^{( v ) T} {W}^{( v )} H ) , s . t . {β}^{( v )} \geq 0 , {\sum }_{v = 1}^{V} {β}^{( v ) 2} = 1$$
the optimization formula of β is simplified as follows:
max f^{T}β,s·t·β≥0,β²^{^{T}}=1
wherein f^{T}=[f₁, f₂, . . . , f_{V}] represents a set of traces of similarity matrices of different views; and fᵥ=tr(Hₘ^{(v)T}W^{(v)}H) represents a trace of the similarity matrix of the v^{th} view.

4. The multi-view clustering method according to claim 3, wherein the steps A1, A2, A3, A4, and A5 further comprise: obtaining an optimized result through singular value decomposition (SVD).

5. The multi-view clustering method according to claim 3, wherein the step A4 further comprises:
constructing a Lagrangian function, and solving a Karush-Kuhn-Tucker (KKT) condition corresponding to the constructed Lagrangian function to obtain an update of Hₘ^{(v)}, wherein the update of Hₘ^{(v)} is represented as:
Hₘ^{(v)}=Hₘ^{(v)}⊗\sqrt{ [symbol]ᵤ(ZHW)/ [symbol] _{I}(ZHW)} [symbol]
ᵤ(ZHW)=2(α^{(v)})²([Φ^{T}X^{(v)}]⁺+[Φ^{T}ΦHₘ^{(v)}]⁻)+λβ^{(v)}[W^{(v)}H]⁺ [symbol]
₁(ZHW)=2(α^{(v)})²([Φ^{T}X^{(v)}]⁻+[Φ^{T}ΦHₘ^{(v)}]⁺)+λβ^{(v)}[W^{(v)}H]⁻
wherein [symbol] ᵤ(ZHW) represents a function for Z, H and W as a numerator of a formula; and [symbol] ₁(ZHW) represents a function for Z, H and W as a denominator of the formula.

6. The multi-view clustering method according to claim 3, wherein the step A6 further comprises:
constructing a Lagrangian function, and solving a KKT condition corresponding to the constructed Lagrangian function to obtain an update of α^{(v)}, wherein the update of α^{(v)} is represented as:
α^{(v)}=Σᵥ₌₁^{V}R^{(v)}/R^{(v)}
wherein R^{(v)}=∥X^{(v)}−Z₁^{(v)}Z₂^{(v)} . . . Zₘ^{(v)}Hₘ^{(v)}∥_{F}² represents a reconstruction loss of the v^{th} view.

7. The multi-view clustering method according to claim 3, wherein the step A7 further comprises:
obtaining a closed-form solution of an updated β according to a Cauchy-Bunyakovsky-Schwarz inequality, wherein the updated β is represented as:
β=f/\sqrt{Σf²}
wherein f represents a set of traces of similarity matrices of different views.

8. A multi-view clustering system based on matrix decomposition and multi-partition alignment, comprising:
an acquisition module configured to acquire a clustering task and a target data sample;
a decomposition module configured to decompose multi-view data corresponding to the acquired clustering task and the acquired target data sample through a multi-layer matrix to obtain a basic partition matrix of each view;
a fusion module configured to fuse and align the obtained basic partition matrix of each view by using column transformation to obtain a consistent fused partition matrix;
a construction module configured to unify the obtained basic partition matrix of each view and the consistent fused partition matrix, and construct an objective function corresponding to a unified partition matrix;
an optimization module configured to optimize the constructed objective function by using an alternating optimization method to obtain an optimized unified partition matrix; and
a clustering module configured to perform spectral clustering on the obtained optimized unified partition matrix to obtain a final clustering result.

9. The multi-view clustering system according to claim 8, wherein the operation of constructing the objective function corresponding to the unified partition matrix in the construction module is represented as:
$$\\ min {\sum }_{v = 1}^{V} {( {α}^{( v )} )}^{2} {‖ {X}^{( v )} - {Z}_{1}^{( v )} {Z}_{2}^{( v )} L {Z}_{m}^{( v )} {H}_{m}^{( v )} ‖}_{F}^{2} - λ tr ( H {\sum }_{v = 1}^{V} {β}^{( v )} {H}_{m}^{( v )} {W}^{( v )} )$$
$$\\ s . t . {H}_{i}^{( v )} \geq 0 , {HH}^{T} = {I}_{k} , {W}^{( v )} {W}^{( v ) T} = {I}_{k} , {α}^{( v )} \geq 0 ,$$
$$\\ {\sum }_{v = 1}^{V} {α}^{( v )} = 1 , {β}^{( v )} \geq 0 , {\sum }_{v = 1}^{V} {β}^{{( v )}^{2}} = 1$$
wherein α^{(v)} represents a weight for a v^{th} view; X^{(v)} represents a feature matrix of the v^{th} view; Zᵢ^{(v)} and Hᵢ^{(v)} represent an i^{th} layer base matrix of the v^{th} view; λ represents a balance coefficient of partition learning and fusion learning; Hₘ^{(v)}, W^{(v)}, and H represent a basic partition matrix, a column alignment matrix, and a consistent fused partition matrix of the v^{th} view, respectively; β^{(v)} represents a weight of the corresponding basic partition of the v^{th} view in a late fusion process; H^{T} represents a transpose of H; and W^{(v)T} represents a transpose of W^{(v)}.

10. The multi-view clustering system according to claim 9, wherein the operation of optimizing the constructed objective function by using the alternating optimization method in the optimization module comprises:
fixing variables Zᵢ^{(v)}, Hᵢ^{(v)}, Hₘ^{(v)}, W^{(v)}, β, and α^{(v)}, and optimizing H, wherein an optimization formula for H is represented as:
$$\\ min - tr ( HU ) , s . t . {HH}^{T} = {I}_{k} wherein U = {\sum }_{v = 1}^{V} {β}^{( v )} {H}_{m}^{( v ) T} {W}^{( v )}$$
represents a partition matrix after fusion;
fixing variables H, Hᵢ^{(v)}, Hₘ^{(v)}, W^{(v)}, β, and α^{(v)}, and optimizing Zᵢ^{(v)}, wherein an optimization formula for Zᵢ^{(v)} is represented as:
min∥X^{(v)}−ϕZᵢ^{(v)}Hᵢ^{(v)}∥_{F}²
wherein ϕ=Z₁^{(v)}Z₂^{(v)} . . . Zᵢ₋₁^{(v)} represents a multiplication of first i^{th} base matrices;
fixing variables Zᵢ^{(v)}, H, Hₘ^{(v)}, W^{(v)}, β, and α^{(v)}, and optimizing Hᵢ^{(v)}, wherein an optimization formula for Hᵢ^{(v)} is represented as:
min∥X^{(v)}−ΦHᵢ^{(v)}∥_{F}²,s·t·Hᵢ^{(v)}≥0
wherein Φ=Z₁^{(v)}Z₂^{(v)} . . . Zᵢ^{(v)} represents the multiplication of the first i^{th} base matrices;
fixing variables Zᵢ^{(v)}, Hᵢ^{(v)}, H, W^{(v)}, β, and α^{(v)}, and optimizing Hₘ^{(v)}, wherein an optimization formula for Hₘ^{(v)} is represented as:
min∥X^{(v)}−ΦHₘ^{(v)}∥_{F}²−λtr(Hβ^{(v)}Hₘ^{(v)T}W^{(v)}+G),s·t·Hₘ^{(v)}≥0
wherein Φ=Z₁^{(v)}Z₂^{(v)} . . . Zₘ^{(v)} represents the multiplication of the first m^{th} base matrices; G=Σ_{o=1,o≈v}^{V}β^{(o)}Hₘ^{(o)T}W^{(o)} represents fusion of other basic partitions except for the partition matrix corresponding to the v^{th} view;
fixing variables Zᵢ^{(v)}, Hᵢ^{(v)}, Hₘ^{(v)}, H, β, and α^{(v)}, and optimizing W^{(v)}, wherein an optimization formula for W^{(v)} is represented as:
min−tr(W^{(v)T}Q),s·t·W^{(v)}W^{(v)T}=Iₖ
wherein Q=β^{(v)}Hₘ^{(v)T}H^{T} represents a product of a similarity of the v^{th} view and the corresponding weight;
fixing variables Zᵢ^{(v)}, Hᵢ^{(v)}, Hₘ^{(v)}, W^{(v)}, β, and H, and optimizing α^{(v)}, wherein an optimization formula for α^{(v)} is represented as:
min(α^{(v)})²R^{(v)},s·t·α^{(v)}≥0,Σᵥ₌₁^{V}α^{(v)}=1
wherein R^{(v)}=∥X^{(v)}−Z₁^{(v)}Z₂^{(v)} . . . Zₘ^{(v)}Hₘ^{(v)}∥_{F}² represents a reconstruction loss of the v^{th} view;
fixing variables Zᵢ^{(v)}, Hᵢ^{(v)}, Hₘ^{(v)}, W^{(v)}, H, and α^{(v)}, and optimizing β, wherein an optimization formula for β is represented as:
$$\\ max tr ( {\sum }_{v = 1}^{V} {β}^{( v )} {H}_{m}^{( v ) T} {W}^{( v )} H ) , s . t . {β}^{( v )} \geq 0 , {\sum }_{v = 1}^{V} {β}^{( v ) 2} = 1$$
the optimization formula of β is simplified as follows:
max f^{T}β,s·t·β≥0,β²^{^{T}}=1
wherein f^{T}=[f₁, f₂, . . . , f_{V}] represents a set of traces of similarity matrices of different views; and fᵥ=tr(Hₘ^{(v)T}W^{(v)}H) represents a trace of the similarity matrix of the v^{th} view.
